(19) United States
(12) Patent Application Publication
(10) Pub. No.: US 2010/0259814 A1
(43) Pub. Date: Oct. 14, 2010

(54) INFRARED COMBAT IDENTIFICATION MARKERS AND PANELS

(76) Inventors: Thomas R. Boyer, Gambrills, MD (US); Douglas Armentrout, Purcellville, VA (US)

Correspondence Address: LATIMER INTELLECTUAL PROPERTY LAW, LLP, P.O. BOX 711200, HERNDON, VA, 20171, US

(21) Appl. No.: 11/693,085

(22) Filed: Mar. 29, 2007

Related U.S. Application Data
(60) Provisional application No. 60/787,666, filed on Mar. 31, 2006.

(51) Int. Cl. G02B 13/14

(52) U.S. Cl. 359/359

(57) ABSTRACT

The invention provides methods of creating and using objects that are detectable in the infrared range of the electromagnetic spectrum. The objects typically have two or more removable elements that are detectable using infrared sensing equipment. The detectable elements are removable from the object for rapid part renewal in the field of use. Particular application is made to the use of such for combat identification.

### CROSS-REFERENCE TO RELATED APPLICATIONS

This application relies on the disclosure of and claims the benefit of the filing date of U.S. provisional patent application No. 60/787,666, filed 31. Mar. 2006, the entire disclosure of which is incorporated herein by reference in its entirety.

### BACKGROUND OF THE INVENTION

1. Field of the Invention

The present invention generally relates to indicia visible to those using night vision goggles and infrared imaging techniques, and particularly to a method of combat identification.

2. Description of Related Art

Users of night vision goggles and infrared cameras for operations, such as the military and police, have the advantage of being able to view all objects in low light, and also to view objects that are heat sources, such as people in complete darkness. However, it remains challenging under those circumstances to positively identify friends and foes. Many combat identification (ID) solutions are being investigated and have been investigated. A subset of the work to date has been termed quick-fix solutions. These are relatively easy to build, easy to implement, low cost tools for the military to help with combat identification until more sophisticated systems can be deployed.

One of the first developments was the Combat Identification Panel (CIP). This item consisted of a number of polished metal slats used to reflect the infrared signature of the sky, which is generally much cooler than that of a military vehicle when placed appropriately. When viewed through a thermal infrared scope, the normally white object has a black, cool looking, object in an unexpected position, identifying the vehicle as friendly.

Following this development, the military has used what has been referred to as the Thermal Infrared Panel (TIP). This panel has a bright orange backing and low emissivity film (emissivity less than 0.4) on the front instead of polished metal slats. When placed on a tank, HMMWV, Bradley, or other asset, it also appears as a black indicia to an infrared camera operating in white hot mode. TIP panels do offer a substantial savings over its CIP counterpart.

However, the down side to this panel is that it is relatively easy to damage in the field. When the panel is damaged the entire panel must be thrown away. This creates significant waste and the logistical problems of continued replacement.

For combat identification while using night vision goggles (NVGs), soldiers frequently use near infrared (NIR) retro-reflective materials. These materials reflect NIR energy from an LED or other energy source directly back at the source. If a person with NVGs is in line with this reflection, it will appear as a mark to them. By placing the retro-reflectors judiciously, soldiers with NVGs and NIR energy sources can identify other soldiers to minimize the chance of fratricide. The difficulty with some retro-reflective products is the inability to easily renew the reflective abilities when the part is damaged.

Among the solutions developed in this field, U.S. patent application publication number US2005/0084975 to Armentrout discloses a marking system viewable in adverse environmental conditions with light amplification or imaging devices but substantially invisible to unaided sight in adverse environmental conditions. The marking system comprises a marker lacking an active visible light emitting element and having a plurality of non-visible light emitting elements capable of emitting infrared energy in distinct portions of the electromagnetic spectrum, a first one of said non-visible light emitting elements further comprising a passive light emitting element.

Another solution is disclosed in U.S. Pat. No. 6,701,649 to Brosi. This patent discloses a marker for attachment to a helmet head covering or the like of a friendly force member. More specifically, it discloses an on-the-go hand securable marker having at least one extension with a retaining head for inserting into a hole in the uniform with the retaining head sufficiently rigid to prevent withdrawal therefrom under field conditions with the marker having a limited wavelength reflective surface thereon to enable a person observing under nighttime conditions to determine if a person is a friendly force member by the presence of reflections of electromagnetic radiation from the marker on the friendly force member. According to the patent, if field conditions change, one can quickly remove the marker and replace the marker with conventional camouflage materials.

Although numerous products exist to assist military and police in identifying friendly personnel in dark or otherwise adverse conditions, there still exists a need in the art for such products, and in particular, products that are relatively lightweight and durable.

### SUMMARY OF THE INVENTION

The present invention provides an object that has on its surface a character, image, or shape that is detectable in the infrared range of the electromagnetic spectrum. In many embodiments, the object is a panel or patch for placement on a vehicle or uniform, such as one used by the military or police. In general, character, image, or shape is placed on a removable element that is attached to the object. Typically, the object is provided with two or more removable elements, although it is envisioned that a single element may be provided, and replaced, when needed, with a new element that was not originally provided with the object. Of course, the invention likewise provides the element as a stand-alone product for inclusion with the object, either during fabrication of the object or as a post-fabrication addition.

The invention further provides a method of making the object of the invention. In general, the method comprises providing an object for which an infrared-detectable signal is desired, and attaching to it an element that has one or more characters, images, or shapes. Preferably, the element is attached in a manner that it is easily removable, such as by peeling, tearing, or ripping, without destroying or unacceptably damaging the object as a whole.

In view of the above aspects of the invention, it is evident that the invention provides a method of identifying, by infrared signal, an object. The method generally comprises providing an object marked with an infrared detectable element, and observing the object to determine if the infrared element is present. The presence of the element, and in particular an element having a pre-defined character, image, or shape, identifies the object as the one desired. Alternatively, the presence of an unexpected character, shape, or image, or the lack of an appropriate infrared signal, identifies the object as one that is not desired.

The panel of the invention comprises primarily two layers, the first layer having a first and second surface and the second having a first and second surface. The first layer comprises a highly visible, durable material such as 1000 denier Cordura nylon in international orange. Other highly visible, durable materials of other colors, materials, or weights can be used. The first surface of the material can be optimized for best visibility. The second surface can be coated with a waterproof coating, such as urethane but this is not required. In some embodiments of the invention, the object (also referred to herein as an article of manufacture) can minimize waste, logistical cost, and usage cost. According to embodiments of the invention, longer-term usage can be combined with low cost to produce a more ideal panel than is currently available. Further, rather than throw away an entire retro-reflective product part, as is currently done in the art, the invention, in embodiments, provides a means to easily renew the reflective material by removing the top layer to reveal a good layer underneath.

According to some embodiments of the object of the invention, the first surface of the second layer is in contact with the second surface of the first layer and fixably attached by some means, such as adhesive or by sewing. The second layer can be made up of multiple sublayers. The sublayers have their first surface adjacent to the second surface of the layer before it and the assembled layer is fixably attached to the first layer. The second surface of each sublayer has the characteristic of being highly discernable in one or more of the near, mid, or far infrared spectrums. In most embodiments, the second layer is made to be renewable so that it can be easily repaired when damaged.

The article of the invention, in exemplary embodiments, comprises two or more sub-layers, each having a first and second surface making up a composite layer that if desired can be placed on one of many different layers having a first and second surface. The second surface of each sub-layer has the characteristic of being retro-reflective to NIR energy. The first surface of each layer has an adhesive having the characteristic of adhering to the second surface of the adjacent sub-layer. The adhesion is such that the sub-layer is not easily removed by accident; however, no residue is left on the second surface of an adjacent sub-layer when the previous sub-layer is removed. The composite layer can be attached to any of a number of carriers including hook and loop fastener or other devices that easily attach to people or objects. Examples of such devices are those based on U.S. Pat. No. 6,701,649 to Brosi, sold commercially by Night Vision Equipment Company, or a similar device commercially available from TVI Corporation.

### BRIEF DESCRIPTION OF THE DRAWINGS

The accompanying drawings, which are incorporated in and constitute a part of this specification, illustrate several embodiments of the invention, and together with the written description, serve to explain certain principles of the invention.

FIG. 1 illustrates one embodiment of the article of manufacture according to the invention, showing a front view of a panel.

FIG. 2 illustrates an embodiment of the invention, showing a side view of the object of the invention.

FIG. 3 illustrates a side view of an embodiment of the invention, showing multiple layers of material.

FIG. 4 illustrates an embodiment of the invention, showing multiple sections of the second layer of an object according to the invention.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description is provided to give the reader a better understanding of various features and details of embodiments of the invention, and should not be considered as limiting the invention in any way.

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form. Throughout the following discussion the variable ‘x’ is used in subscript to represent any one of a set of like laminar layers. ‘1 ’ when used in subscript represents the first of a set of like laminar layers. Finally ‘n’ when used in subscript represents the last of a set of like laminar layers.

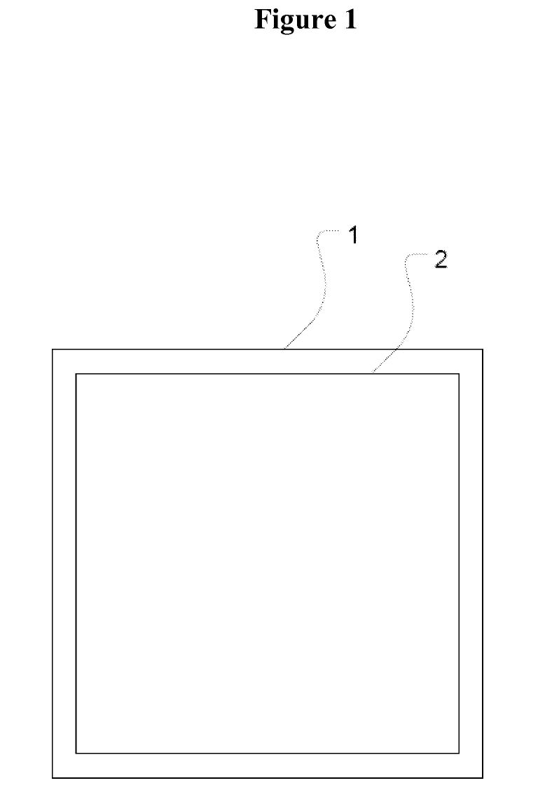

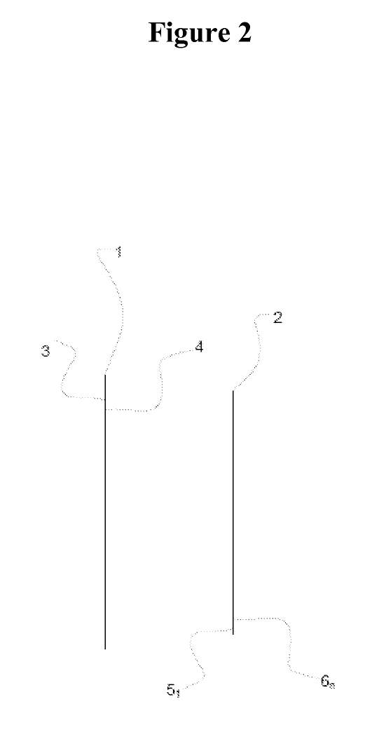

One embodiment of the panel comprises or consists of two layers. In this panel, the first layer 1, shown in FIGS. 1 and 2, has a first surface 3 and second surface 4, shown in FIG. 2. It comprises or consists of a highly visible, durable material, such as 1000 denier nylon fabric in international orange. Of course, other highly visible, durable materials of other colors, materials, or weights can be used. The first surface 3 of the material is optimized for best visibility. The second surface 4 can be coated with a waterproof coating such as urethane, but this is not required.

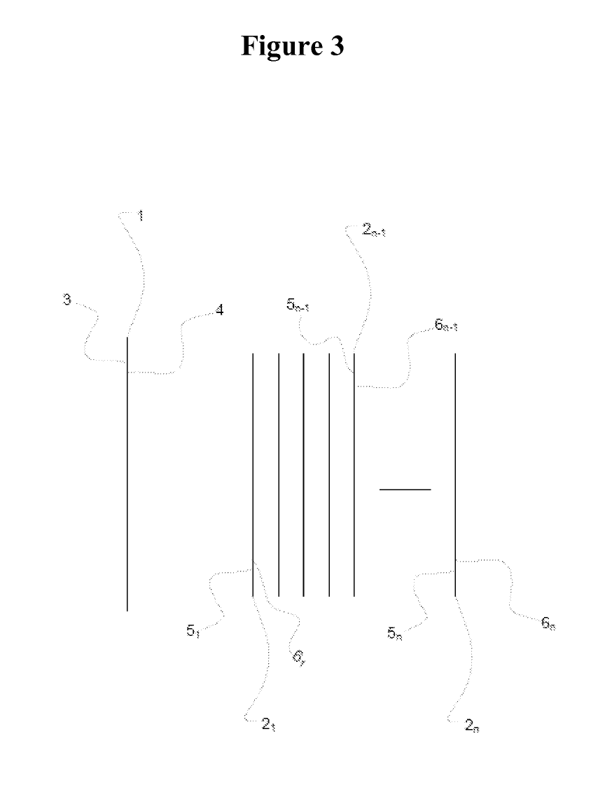

The second layer 2, shown in FIGS. 1 and 2, likewise comprises or consists of a first surface 5₁ and second surface 6ₙ, shown expanded in FIG. 3. This layer is a composition of one or multiple identical sublayers made from thermal IR reflective material (e.g., no power material, reverse polarity material), each having a first surface 5ₓ and second surface 6ₓ, as shown in FIG. 3. The first surface of each sublayer 5ₓ is in contact with the second surface 6ₓ₋₁ of the sublayer below it. The first surface of the composite second layer 5₁ is in contact with the second surface of the first layer 4 and fixably attached, for example by sewing around the edges. The seams are finished using fabric bias, fabric tape, webbing, or any other suitable means. The needle pitch and diameter is such that a perforation is created around the edges. The strength of the material that remains at the edges is such that the layer 2ₙ cannot be easily removed accidentally. On the other hand, when desired, the layer 2ₙ can be removed with concerted tensile force applied to the layer, such as by intentional pulling by a human, or by a human assisted by a mechanical device. This will expose layer 2ₙ₋₁ for use. Such removal would be warranted when the exposed layer 2ₙ was damaged. The second surface of each sublayer 6ₓ has the characteristic of being highly discernable in the mid and far infrared wavelength spectra. One characteristic of the material is that it is highly reflective to thermal infrared energy. Another characteristic is that it has a very low emissivity (emissivity value less than 0.4). When these characteristics are present, the material generally looks darker than its surroundings when viewed through a thermal infrared camera set in white hot mode.

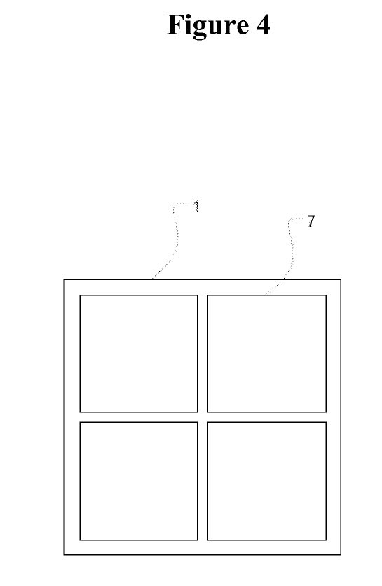

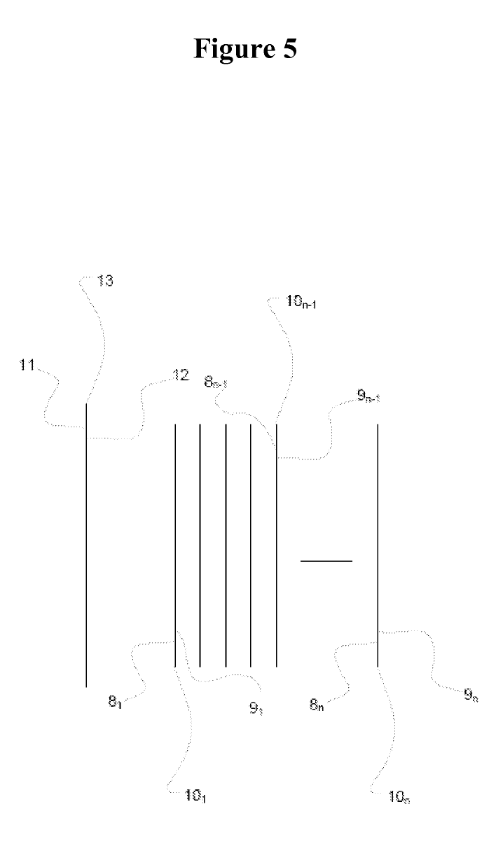

In an alternative embodiment, shown in FIG. 4, composite layer 2 (shown in FIG. 1) is divided into multiple sections to form composite layer 7. Composite layer 7 has the same characteristics as composite layer 2 except it is smaller allowing multiple sections to a single panel. FIG. 4 shows four discrete sections, however, there could be more or fewer sections. The composite layer 7 can be attached to layer 1 utilizing the same means defined for layer 2. The division into separate sections allows removal of less material should localized damage occur to the top layer. One purpose of this is to minimize the rate of film usage thereby increasing the panel life.

In an alternative embodiment, the sublayers adhere to each other using a light tack adhesive, which leaves no residue on the sublayer below it when that sublayer is removed.

In yet further embodiments, such as those shown in FIG. 5, the invention provides an object that comprises or consists of two or more sublayers 10ₓ, each having a first surface 8ₓ and second surface 9ₓ making up a composite layer that, if desired, can be placed on one of many different bodies 13 having a first surface 11 and second surface 12 or bodies of any geometry. The second surface 9ₓ of each sub-layer has the characteristic of being retro-reflective to near infrared electromagnetic energy. The first surface 8ₓ of each layer has an adhesive having the characteristic of adhering to the second surface 9ₓ of the adjacent sublayer. The adhesion is such that the sublayer is not easily removed by accident; however, negligible or no residue is left on the second surface 9ₙ₋₁ of an adjacent sub-layer 10ₙ₋₁ when the previous sub-layer 10ₙ is removed. Additional means of fastening other than through the use of adhesive are also contemplated. The composite layer can be attached to any of a number of carriers, including hook and loop fastener or other devices that easily attach to people or objects. Examples of such devices are those disclosed in U.S. Pat. No. 6,701,649 to Brosi, sold commercially by Night Vision Equipment Company, or a similar device commercially available from TVI Corporation.

It will be apparent to those skilled in the art that various modifications and variations can be made in the practice of the present invention and in construction of this article of manufacture without departing from the scope or spirit of the invention. Other embodiments of the invention will be apparent to those skilled in the art from consideration of the specification, the drawings, and practice of the invention. It is intended that the specification, drawings, and examples be considered as exemplary only, with a true scope and spirit of the invention being indicated by the following claims.

1. An article of manufacture comprising a laminate structure, said article of manufacture comprising:
a panel comprising a first and second surface,
wherein the first surface is visible in the optical portion of the electromagnetic spectrum, and the second surface is discernable in one or more of the near, mid, or far infrared portions of the electromagnetic spectrum,
and wherein the second surface is renewable or repairable.

2. The article of manufacture of claim 1, wherein the first surface is international orange.

3. The article of manufacture of claim 2, comprising removable at least one adhesive-backed film layer having an emissivity value less than 0.4.

4. The article of manufacture of claim 2, wherein the second surface is renewable and comprises multiple pre-cut layers of adhesive-backed film layers with an emissivity value less than 0.4 that can be placed over damaged layers.

5. The article of manufacture of claim 2, wherein the second surface comprises multiple film layers, each with emissivity values less than 0.4, and each of which can be removed individually.

6. A laminar system comprising the article of manufacture of claim 5, further comprising means to individually grasp a layer of film with emissivity value less than 0.4.

7. The laminar system of claim 6, wherein the layer of film comprises at least one perforation that assists in removal of the layer after grasping of the layer.

8. The laminar system of claim 7, wherein the perforation is made by sewing the low emissivity film around its edges with or without thread.

9. The laminar system of claim 6, wherein the layer of film is damaged.

10. The laminar system of claim 9, where the second layer is divided into a number of smaller surfaces, each comprising multiple film layers with emissivity value less than 0.4 that can be removed individually.

11. A multi-layer laminar assembly of identical parts in which each individual part comprises a first and second surface, wherein the second surface is retro-reflective to energy in the near infrared portion of the electromagnetic spectrum, and is minimally reflective in the visible spectrum.

12. The laminar assembly of claim 11, wherein the assembly is formed by bonding each member to the one below it.

13. The laminar assembly of claim 12, wherein an adhesive is used to bond the individual members.

14. The assembly of claim 13, wherein the adhesive will leave little or no residue on the second member below it when the first member is removed, and wherein the adhesive holds the two members together such that the members are not easily removed.

15. The assembly of claim 11, wherein the members are held together using mechanical means.
